(19) United States
(12) Patent Application Publication
(10) Pub. No.: US 2006/0156052 A1
(43) Pub. Date: Jul. 13, 2006

(54) Method and apparatus for management of data on handheld devices

(76) Inventors: Eric O. Bodnar, Santa Cruz, CA (US); Perry Tobin, Santa Cruz, CA (US); Daniel Abram Galpin, Santa Cruz, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/262,030

(22) Filed: Oct. 27, 2005

Related U.S. Application Data
(60) Provisional application No. 60/623,076, filed on Oct. 27, 2004.

(51) Int. Cl. G06F 11/00

(52) U.S. Cl. 714/2

(57) ABSTRACT

A method and apparatus for a backup and restore service is provided. The backup and restore functionality provides the ability to use fleet-based provisioning, as well as the ability to delete personal data from a lost handset. Since restoration is also possible using this system, if the handset is recovered—or replaced by a new handset, the address book can be easily restored/transferred.

### RELATED CASES

This application claims priority to Provisional Patent Application Ser. No. 60/623,076, filed Oct. 27, 2004.

### FIELD OF THE INVENTION

The present invention relates to data backup, and more particularly to enabling a backup and restore functionality using a backup server.

### BACKGROUND

Synchronization services are often employed as data backup services. But, because they are multi-purpose and do not have strict behavior and instead rely on best-guess heuristics, synchronization services cannot be relied upon for data integrity.

Synchronization systems match two or more equal peers in a data relationship. In such a relationship, there is no master data authority and any peer can contribute a change to the data set. Because synchronization must deal with data records of varying types, it must employ heuristics to identify matching records and isolate record differences. Synchronization performs record translation since any two nodes in a synchronization network may have differing record structure and formats.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a network diagram illustrating one embodiment of the relationship between the elements of the system.

FIG. 2 is a block diagram of one embodiment of the Backup and Restore (BAR) server.

FIG. 3 is a block diagram of on embodiment of the BAR server used for fleet operation.

FIG. 4 is a block diagram of one embodiment of the BAR client residing on a handset.

FIG. 5 is a diagram illustrating one embodiment of the two-dimensional format of the backups stored in the system.

FIG. 6 is a flowchart of one embodiment of using the BAR server.

FIG. 7 is a flowchart of one embodiment of using the fleet operation-based BAR server.

FIGS. 8A-C are user interface images of a web interface associated with the BAR server.

FIG. 9 is a block diagram of one embodiment of a computer system which may be used with the present invention.

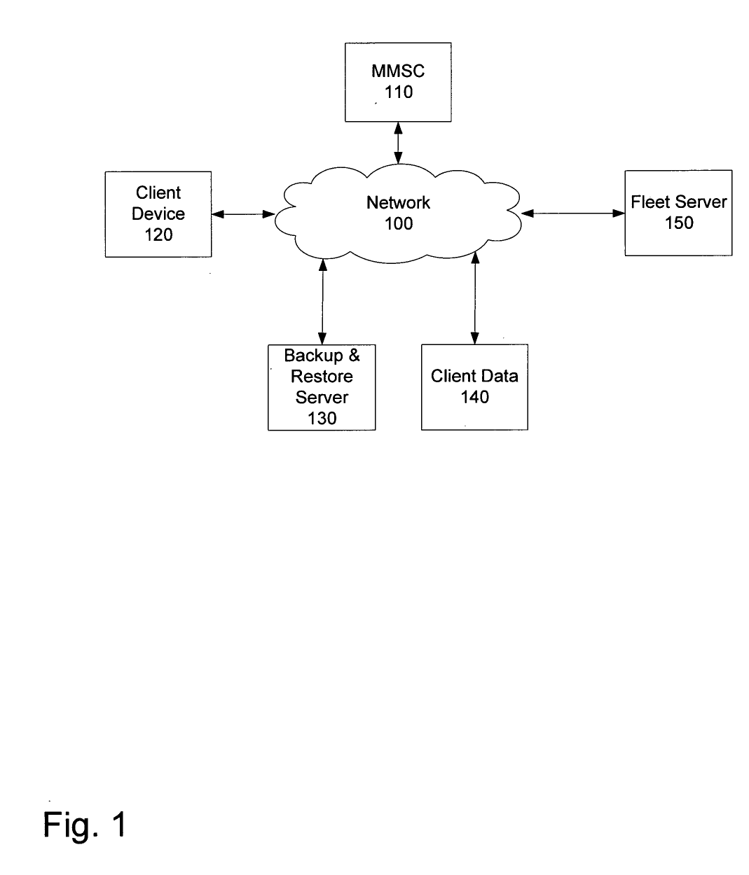

### DETAILED DESCRIPTION

A Backup And Restore (BAR) service provides periodic, automated backup of mobile phone address book information onto a secure server, using the wireless mobile network. BAR can be used, in one embodiment, to restore address book information to an original handset in case of damage or accidental loss. BAR can be used to transfer address book information to a new, upgraded handset or to a replacement handset. BAR can also be used to pre-install address book information onto fleet deployed mobile handsets, reset fleet handset address book information to a known state, or obliterate information in a stolen or lost handset.

BAR service can be deployed as a personal mobile backup service, in one embodiment. In one embodiment, the BAR service may be deployed as a fleet data deployment service. The features for each configuration are summarized as below.

Personal Mobile Backup Service

The personal mobile backup service configuration is designed for individual subscribers as a data backup and protection mechanism. The BAR system provides backup and restore services and address book migration services. In one embodiment, the personal mobile backup service provides an online read-only view of address book information within an individual subscriber account.

In one embodiment, the personal mobile backup service of BAR employs selective provisioning to allow activation on an individual subscriber basis. The service can be enabled at time of phone purchase or selectively by the subscriber at a later date. Because the embedded client is already present in the mobile handset, a simple over the air provisioning code (IOTA) is all that is required to activate or deactivate the service.

In one embodiment, the BAR server 130 relies on the underlying multi-media messaging system (MMS) infrastructure of the handset 120 and the carrier 110. For data backup messages to be delivered to the backup server, MMS messaging is used, in one embodiment. Thus, in one embodiment, the user's handset must support MMS messaging in order for the BAR to work. In one embodiment, the “notification layer” may use simple mail transfer protocol (SMTP). Messages sent to the handset, or by the handset, may be in various formats including MMS, SMS (simple messaging system), HTTP (hypertext transfer protocol), SMTP, IP (internet protocol), or any other error-free protocol.

The BAR service, once activated, will automatically backup data. Whenever a commit is issued by the embedded address book application within the handset (e.g. after making a change to a contact entry), the BAR client constructs a backup record to send to the server as an MMS message. In one embodiment, the backup record is sent immediately. In another embodiment, the backup record is sent to the server periodically, such as once per day. In yet another embodiment, the system queues the new backup record to be sent to the server when network utilization is low. The backups are automatic, and no user intervention is needed.

The client data 140 is stored securely. In one embodiment, the client data 140 may be stored in a database. In another embodiment, the client data may be stored in a flat file, or an alternate format. In one embodiment, the BAR system also can interact with a fleet server 150 to provide fleet provisioning, backup, and restore to pristine state.

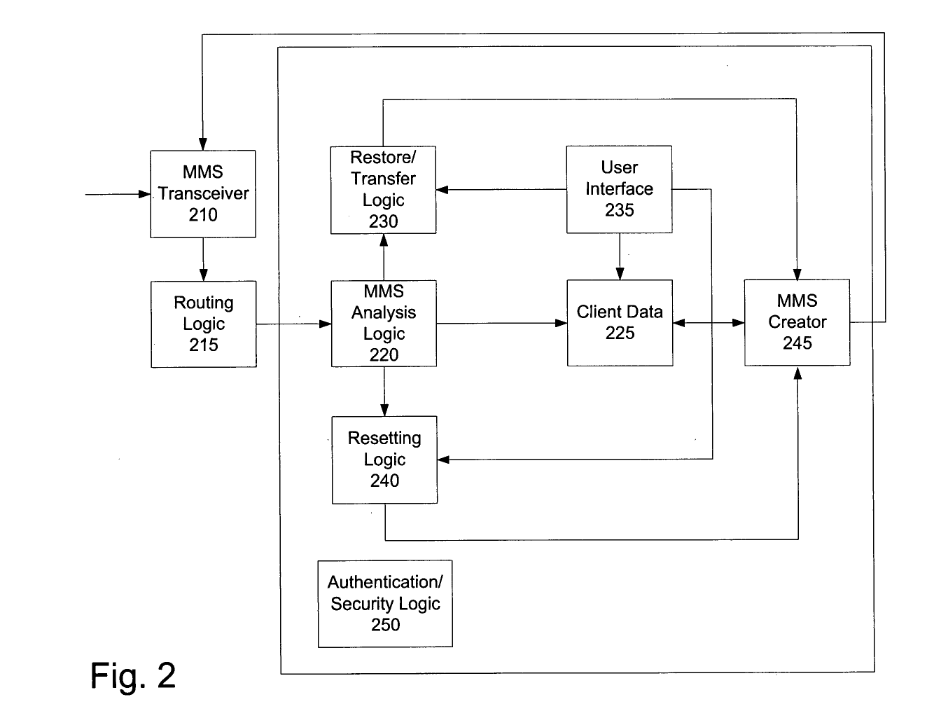

FIG. 2 is a block diagram of one embodiment of the BAR server. In one embodiment, the personal version of BAR will provide a read-only data view of the backup copy of the address book on the BAR web site through user interface 235. In one embodiment, the web site is white labeled and can be re-branded and accessed within another web site (e.g. the web site of a mobile operator or a corporate intranet). Using the BAR website, a subscriber can view the current backed-up version of his/her address book 225. In one embodiment, the system maintains a “last known good state” of the address book, if there are any problems with a backup. In one embodiment, the system further maintains a transaction history since activation of the service. In one embodiment, this client data 225 including the history enables the user to set back the system to a previous state.

From the BAR website, a subscriber can initiate a restore to his/her handset by selecting the “restore” option. In one embodiment, selecting the restore option requires proof of handset ownership. Authentication/security logic 250 enforces this rule. In one embodiment, proof of ownership is handled via an SMS message, as part of the restore process (described later).

For handset upgrades or handset replacements, a subscriber can manually transfer backed up address book information to a new handset using the BAR website. Restore/transfer logic 230 assists in this process. In one embodiment, the procedure for transfer is identical as that for restore except that the subscriber enters the telephone number of the replacement handset, if it is different from the original telephone number.

Optionally, the subscriber can use the BAR website to manually append additional records to the address book using user interface 235. This is an optional feature provided as a convenience for those subscribers who wish to use a personal computer to enter new contacts rather than the handset keypad. In one embodiment, new contacts will be added to the address book shown in the website view and to the handset via MMS message.

For lost handsets, in one embodiment, a subscriber or a support clerk can issue a manual data reset to the handset, via resetting logic 240. A manual reset will obliterate the data in the handset address book, call history list, and missed call list, assuming a connection to the lost handset can be established. Manual reset will not affect the backup copy of the information on the BAR server. In one embodiment, an obliterated address book can be recovered at any time using the restore operation. The restore/delete and other messages are sent to the handset via multimedia messaging. Multimedia message creator 245 creates the message, based on the information the user has entered. This is then sent to the MMS transceiver 210. In one embodiment, the message is in MM7 format, sent to the MMSC, which then sends it to the user's handset. In another embodiment, the message is in MM1 format, sent directly to the handset.

In one embodiment, the BAR will provide a customer support interface, through user interface 235, which allows carrier customer support personnel to issue restore, transfer, or reset instructions to a subscriber handset. In one embodiment, the customer support interface provides only non-personal information about a particular subscriber account, such as number of contacts and a list of backup dates. The customer support interface will not display the contents of a subscriber address book. In addition to specific subscriber account information, in one embodiment the customer support tool will also provide statistical data. Statistical data may include number of active subscribers, average address book size, and frequency of backups.

Fleet Data Deployment Service

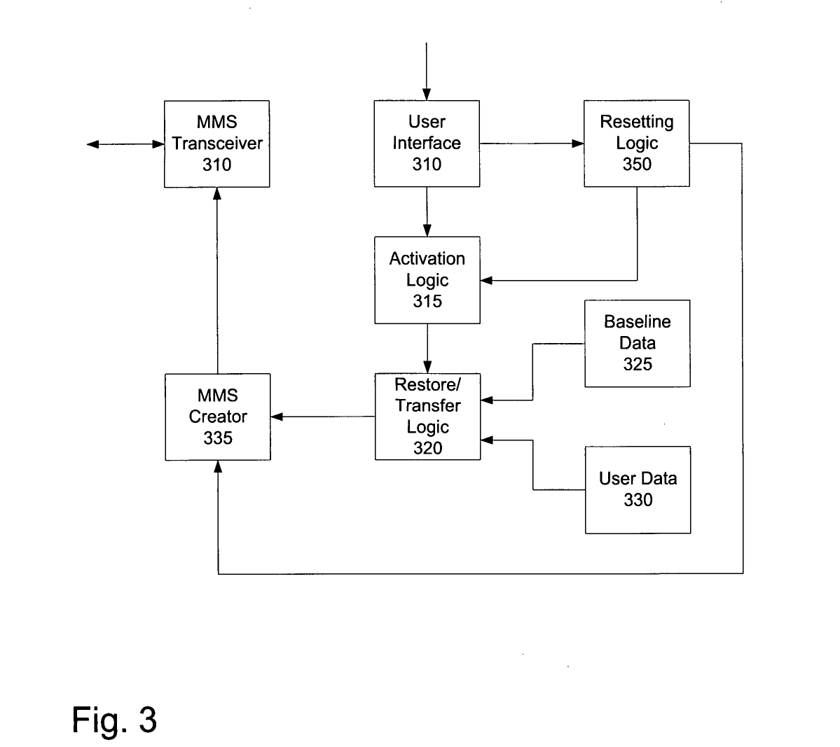

FIG. 3 illustrates a block diagram of the BAR Fleet server. The BAR fleet data deployment service configuration is designed for fleet services, such as rental car programs, to provide a mechanism for resetting handset address book information and for allowing customers a convenient method for temporarily storing information in a rented handset. Fleet services may also include corporate organizations which provide handsets to employees. Any organization that wishes to provide centrally controlled handsets to users/members may utilize the fleet data deployment service of the BAR. For simplicity, the term “rental mode” is used to describe a handset that is operational. Of course, one of skill in the art would understand that this does not require a “rental” but refers to any in-use handset used in such a manner.

With BAR, provisioning is by fleet/group rather than by individual subscriber. Each account is valid for the time that the handset is in rental mode and is reset once the handset is returned. Activation logic 315 activates the handset when it is placed into fleet/rental mode, and deactivates the handset after it is returned. Individual subscriber accounts, and the associated user data 330, are dissociated from handsets prior to handset issuance and after handset decommissioning. In one embodiment, individual subscriber accounts can persist after decommissioning. This may be useful, for example, in a corporation having offices in various locations, which provides fleet handsets. A traveling user may receive a local handset, with the user's own address book, as well as the local corporate address book, designated baseline data 325, already preinstalled. Restore/transfer logic 320 is used, in one embodiment, to identify content to be added to the device.

In one embodiment, the BAR supports a fleet data reset facility. Fleet data reset automatically activates once a handset is returned and a fleet clerk resets the associated account. Resetting logic 350, in one embodiment, obliterates all stored address information in the handset and replaces it by a default address book controlled by the fleet agency. For instance, the default address book might contain emergency numbers and customer service numbers. The customer account link to the returned handset is also broken. However, the customer account may remain active and may continue to persist after the handset has been returned and reset. Customer account data is stored as user data 330.

In one embodiment, using the user interface 310 on the BAR website, individual subscribers can transfer contact information to the rental phone. Once a handset is commissioned, the individual user account information will be linked to the handset and the data transferred. When the handset is returned and reset, the account information will be unlinked from the handset. Thus, for example, a person may add their personal address book to the previously installed default address book by linking the personal address book on the BAR server to the telephone number of the rental handset. Multimedia message creator 335 creates the message, based on the information entered through user interface 310, or received via MMS message. This is then sent to the MMS transceiver 310, for the handset.

In one embodiment, the BAR service uses a clearly defined mechanism for data backup. This mechanism is singular in purpose and does not allow for ambiguity in logic or data storage. Because the service will be relied upon for data integrity, the strictest definition is followed. Unlike synchronization, BAR personal data deployment service has a very specific master-slave relationship, with the handset client acting as the master and the backup server as the slave. BAR fleet data deployment service has the opposite master-slave relationship, with the handset client acting as the slave and the fleet server as the master.

BAR is not a data synchronization service. BAR does not perform record matching. Instead, BAR considers each slot in the handset an individual record and archives a complete history of all modifications to that record slot on the BAR server. BAR records only the data as it is represented within the handset.

Synchronization must perform conflict resolution whenever modifications are detected from multiple peers to the same record. This often requires user intervention. On the other hand, because BAR has a clearly defined mobile client to server relationship, there are no conflicts for it to resolve.

Synchronization can fail to recognize the difference between a change to a record and an intended duplication of a record. This frequently encountered edge case is known as duplicate collision and requires the use of duplicate management automata to resolve the conflict or, in most cases, manual user intervention. BAR does not suffer from duplicate collision because all transactions are slot based and intended duplicates are taken literally.

BAR is a data backup service. It is intended to provide a literal backup of a mobile handset address book that can be used, at a later date, for restoration or transfer to a new handset. For every record that is modified on the handset, a corresponding entry is created on the server. In one embodiment, every modification to a record is kept as part of a chronological history, associated with that particular record by the server. In one embodiment, each “update” creates a new entry in the timeline. In one embodiment, updates are grouped by date and time. Thus, for example, all updates done on a particular date may be combined into a single “update.” Using this mechanism, the address book can be restored to any particular state along a historical timeline.

As summarized previously, BAR archives each mobile handset record literally and does not attempt to transmute it or transform any record into a peer or into a canonical format. BAR does not attempt to perform record matching but, rather, tracks each record by its position (slot) within the mobile handset. BAR considers every modification (add, edit, delete) as a historical transaction and does not attempt to resolve the “winning” transaction in a conflict. In fact, because each transaction occurs in a set position along an historical timeline, there are no conflicts. BAR does not attempt to identify or merge duplicates; all record transactions are taken literally.

BAR consists of two components, a client software component on the user's handset, and a secure backup and storage service on a remote server. In one embodiment, the secure backup and storage server is operated in a failsafe manner by a service provider. In one embodiment, the server is accessible to the user's handset via a messaging service. In one embodiment, the client is pre-installed onto a handset. This means that no downloadable client software is required. The BAR requires no PC software, cables, or any other additional hardware or software elements to function. In one embodiment, BAR operates seamlessly and automatically using a wireless carrier's existing multimedia message service (MMS) infrastructure. Alternatively, the short messaging system (SMS) infrastructure may be used. Alternatively, a session initiated protocol (SIP) based connection may be used.

In one embodiment, the BAR handset client is provided to handset manufacturers for direct integration into the handset. In another embodiment, the BAR handset client is provided as an installable handset application.

The BAR server, in one embodiment, will be maintained and operated by a single service provider under contract to carriers. In another embodiment, each carrier may maintain its own BAR server. In one embodiment, the server is coupled to the wireless carrier's network via the MM7 interface of the carrier's multi-media messaging service center (MMSC).

In one embodiment, the service provider and the carrier user a fixed destination identifier (e.g. a short code address) to identify backup messages that are to be forwarded to the service provider. The short code address is then programmed into handset clients in order to address the BAR server. In one embodiment, the carrier may update the data in the client, to change this short code address. The server will archive all transactions issued over MMS, via MM7, within a secure storage area accessible only by the individual handset owner.

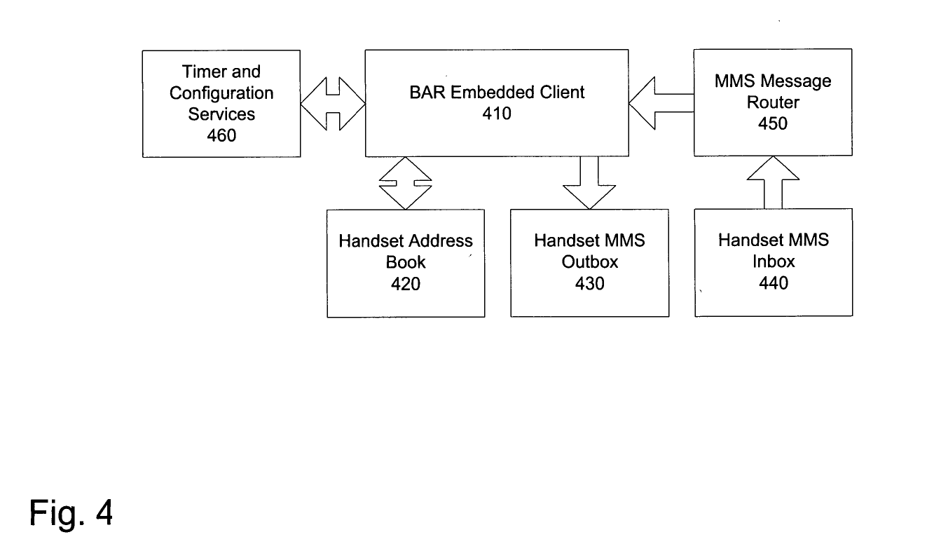

FIG. 4 is a block diagram of one embodiment of the client application. In one embodiment, the client application is functional and pre-installed as a component of the embedded firmware of a mobile handset.

In one embodiment, the client is permanently activated. There is no ability to enable or disable the client. Any change to address book information within the handset instructs the client to package and send an MMS message to the pre-programmed MMS address for the BAR server.

In another embodiment, the client is soft activated. An over-the-air (OTA) provisioning command will set or reset the enable flag for the client. In one embodiment, the OTA command is sent via SMS to the phone. If enabled, any change to address book information instructs the client to package and send an MMS message to the pre-programmed MMS address for the server. When the system is not enabled, no such messages are sent.

In one embodiment, upon initial activation, the BAR client packages and sends the contents of the handset address book to the BAR server. This first step is to initialize the server copy. After initialization, upon subsequent data commit within the handset resident address book, the BAR client will package up and send an MMS message containing the contact record changes. Commits include additions, changes and deletions. In one embodiment, the data commit occurs when the user exits the editing feature. Thus, in one embodiment, more than one item may be changed in an editing session, before a commit occurs.

Restoration, or uploading of the last known good address book from the server is triggered, in one embodiment, from the BAR web site. In another embodiment, it is trigged on the handset, using the BAR client. In one embodiment, if a restore is triggered, the BAR server sends a message with the data to the user's handset. In one embodiment, the message is an MMS message. The BAR client will respond to the message from the BAR server by replacing entries within the handset address book with corresponding entries in the MMS message.

In one embodiment, the client will respond to server MMS messages as follows:

(1) Complete address book: a complete address book will replace the entire contents of the handset address book with the new file. The complete address book may be blank. The message from the BAR server indicates whether the message is a complete address book or a subset of the address book.

(2) Single address entry: a single address entry will replace only the specified address book entry within the handset address book. An entry may be blank.

(3) A subset of entries: the message may include a subset of entries, which are replaced within the handset.

In one embodiment, the BAR server sends an empty address book to obliterate the handset address book. In another embodiment, receipt of an empty address book will subsequently lock the device into an inoperative state. In another embodiment, a separate message may be sent to lock down the device. Locking down the device may be useful if the device is lost or stolen.

In one embodiment, the BAR server sends a signal message to obliterate the handset. In one embodiment, the signal message is and address book with specific keyword signal content. In one embodiment, the signal message contains display information, such as a “please return to owner” message, to be displayed on a locked device.

In one embodiment, all address book entries, either singular or contained within a complete file, will contain a labeled field indicating the corresponding handset address book slot number to which the entry applies. In one embodiment, the address book entries are transmitted in the vCard format. Alternative formats may be used. In one embodiment, the BAR determines what format(s) the user's handset supports, and ensures that data is transmitted in the proper format.

In one embodiment, there is no handset user interface for the BAR client. The operation is transparent to the user. Except for user notification of error conditions, it is a faceless client. Error conditions that require user action appear as message boxes on the handset, in one embodiment. In another embodiment, short SMS-format messages are sent to the handset from the server to indicate error conditions. Error conditions may include the following:

(1) No MMS service

(2) MMS outbox full

(3) Address entry corresponding to a non-existent slot number

(4) Address book memory full

(5) Unsigned MMS message from the server

In each of these error message cases, the user is notified of the problem. In one embodiment, the user may indicate the preferred solution.

The data format for the MMS message sent between the BAR server and the BAR client is a vCard, in one embodiment. In one embodiment, in order for the BAR client to process and act on the contents of the vCard message, the message must be signed by the server with a digital fingerprint and each address book entry must contain a valid corresponding slot number. In one embodiment, unsigned vCard messages are treated as insecure address notifications and will result in an error notification. In one embodiment, the user may choose to install such an insecure address notification.

The BAR server is made available, in one embodiment, as an MM7 connected MMS service. In another embodiment, the BAR server is integrated into the carrier website as a feature service. In one embodiment, BAR server web interface is provided through a separate server.

Subscriber authentication and access verification, in one embodiment, is handled by the carrier website. The carrier is responsible for maintaining a unique BAR subscriber identification, corresponding to a particular user name (mobile number) and password.

The BAR server uses an automated provisioning mechanism, in one embodiment. The BAR server will generate new unique subscriber IDs for non-existing accounts automatically, the first time a backup message is received.

In one embodiment, the BAR server is implemented as a sub-component of the carrier's website. Navigation to the BAR service will be through the carriers existing website tab or navigation structure. In one embodiment, the technique described in U.S. patent application Ser. No. 10/125,049, filed Apr. 17, 2002, entitled “System Providing Methods For Dynamic Customization And Personalization Of User Interface,” is used to create a customized interface that matches the interface of the carrier's own website. In one embodiment, BAR provides an interface that provides color coordination and style to match the carrier's existing format and style. Thus to the user, the service appears to be provided by the carrier, although the actual service may be provided by a third party service provider.

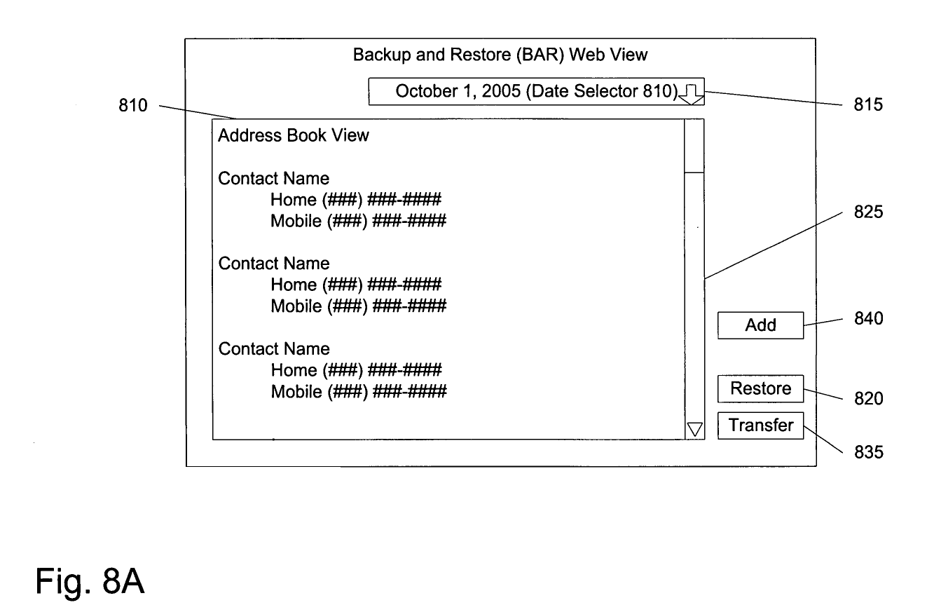

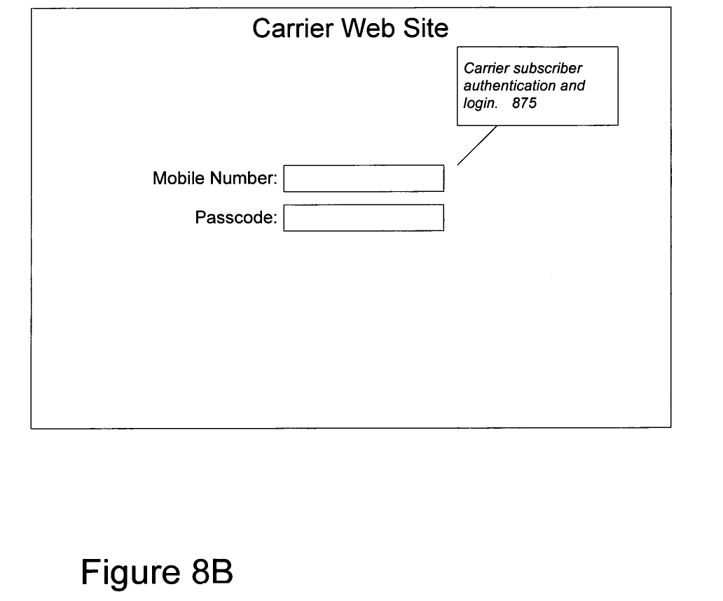

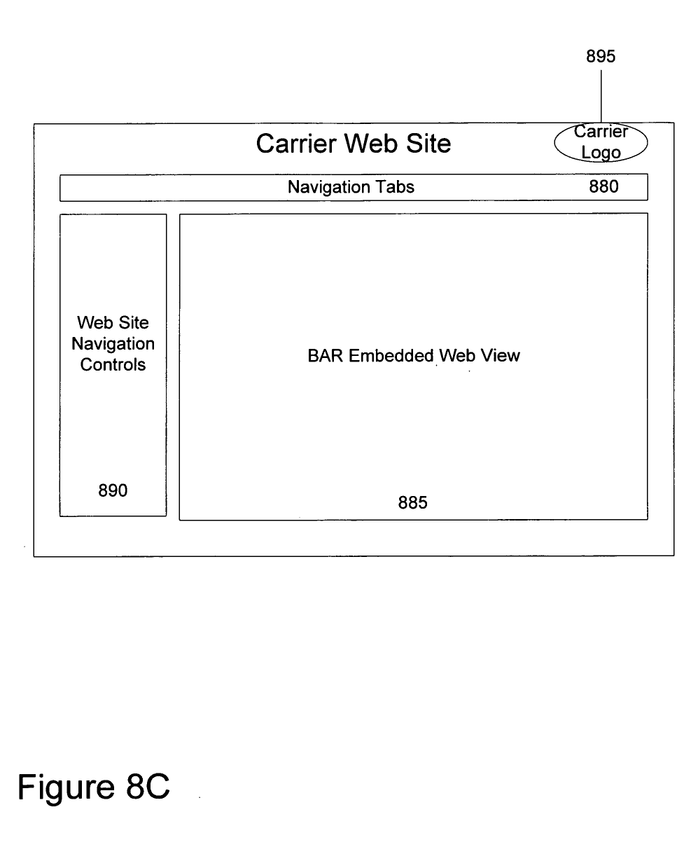

In one embodiment, the BAR web interface includes the ability to view historical backups of the address book. In one embodiment, the user may restore any historical version of the address book to the handset. The web interface, in one embodiment, includes a view of the address book, a date selector, and buttons to activate restoration. FIG. 8A illustrates one embodiment of the address book (810), including the currently viewed date (815). The user can select the date 815, to view a past state. In one embodiment, the user can “restore” the handset to that state, using the restore button (820).

In one embodiment, the BAR web interface will contain a date selector 815 with entries corresponding to logged change events within the address book. In one embodiment, the date selector will be in reverse chronological order with the most recent date first. Selecting a particular date will re-display the address book in the state that corresponds to that particular date along the address book historical timeline.

The address book view 810 will contain all address book entries in the address book corresponding to the date selected in the date selector 815. The view, in one embodiment, is scrollable 825 if the number of entries exceeds the displayable area. The view, in one embodiment, contains only the information within each address book entry that can be restored to the handset. The address book view is read-only, in one embodiment. In another embodiment, the user may edit 830 a version of the address book on the web page. In one embodiment, the system stores this as another update, i.e. it maintains the historical state prior to the changes.

The web interface includes restore 820 and transfer 835 links to restore or transfer the currently visible state of the address book to the subscriber's handset. In one embodiment, the data may be transferred to the user's existing handset or to a new handset. In one embodiment, restore and transfer are nearly identical operations with the only difference being the ability to specify a specific mobile number using the transfer option.

In one embodiment, the user may select one or more of the addresses from the currently displayed version of the address book, and transfer the subset of selected addresses to the handheld.

In one embodiment, the restore and transfer functions are unified into a single “restore” function that always asks for handset number verification prior to restoration.

In one embodiment, the web site includes an “add” link 840 that allows the subscriber to compose a new address book entry and append it to the most recent version of the address book. The new entry form will conform to the field format within the handset and will not contain values that cannot be saved within the handset. Upon submission, the new entry form will append the contact information to the address book and record the entry as a historical modification to the address book. If required, a new historical label will be added to the timeline corresponding to the addition of the new entry.

In one embodiment, the granularity of historical labels within a particular address book history is a single day. All modifications made to an address book on the same day will be normalized to a single, unified event for that day. In one embodiment, the normalization process is server driven and does not depend on the handset issuing a combined MMS message containing all modifications for a particular day. In one embodiment, to avoid confusing the subscriber, time normalization is represented in handset local time and not in GMT. In another embodiment, the handset may only transfer data to the BAR server once per day, and thus will accumulate changes until the transfer time.

In one embodiment, restoration and transfer are identical functions with a single difference; “transfer” allows the subscriber to specify a particular mobile number while “restore” assumes the original (archiving) mobile number is the target. Selecting transfer or restore will perform a restoration of the address book state currently visible in the address book view, as indicated by the date selector. In one embodiment, since only the handset owner has access to the user's data on the web page, no validation is required. In another embodiment, restoration or transfer, in one embodiment, requires a separate validation of handset ownership. In one embodiment, this is performed as follows:

(1) the BAR server will generate a dynamic, numerical PIN code of no more than six digits and no fewer than four digits

(2) the BAR server will send the PIN code as an SMS message to the handset

(3) the BAR server will request that the subscriber enter the PIN code sent to the handset, using the website, prior to starting the restore or transfer

(4) upon verification of valid PIN code, the BAR server will package up the address book, or selected portion of the address book, and send it as an MMS message to the handset

(5) the MMS message sent to the handset will contain a digital signature created by the BAR server.

In one embodiment, all files sent from the BAR server are signed with a digital signature which corresponds to subscriber and handset specific information that can be verified by the handset. In one embodiment, the embedded BAR client will reject or require manual acceptance of any unsigned restore/transfer messages.

In one embodiment, the “add” link on the BAR website will trigger the display of a web form containing entries corresponding to name-value pairs matching the contact format for a single contact entry. Upon form submission, the new contact data entered by the subscriber will be appended to the address book into an empty slot as a historical modification to that particular slot. In one embodiment, the user may similarly edit any entry.

The BAR service uses an enabled multimedia message service (MMS) subsystem within the handset in order to deliver address book update messages, and send out backup messages. In one embodiment, the MMS subsystem includes a functioning MM1 stack within the handset, a message router that can activate the BAR client upon receiving an MMS vCard, a functioning multimedia message service center (MMSC), an MMS destination address (short code) for the BAR service and an active MMS account for the subscriber.

In one embodiment, the multimedia message service center (MMSC) and client resided MM1 stack must both support the vCard data format as a valid MMS message payload. Neither the MM1 stack nor the MMSC may alter the contents of the vCard data.

If the option for soft activation of BAR is selected, the carrier network and handset, in one embodiment, uses an over-the-air provisioning method. This method reliably alters the state of the BAR service enablement setting.

In one embodiment, the BAR server uses a standard MM7 connection to the multimedia message service center (MMSC) and a corresponding MMS destination address (short code). The MM7 interface does not require that the BAR server and the MMSC to be collocated. However, in one embodiment a secure link between the two systems is used. In another embodiment, the connection may be over an MM1 link, by having the server act as if it were another MMSC.

The BAR client requires functional connectivity to components within handset firmware. In one embodiment, connectivity is via a set of defined application programming interfaces (APIs). An exemplary set of these interfaces are summarized below.

The BAR client in one embodiment has direct connectivity to the handset address book client for the purposes of adding, removing and modifying address book entries. Some exemplary commands which may be used by the system are:
(1) ResetAddressBook( ): This API command is issued by the BAR client to the embedded address book. The address book responds by erasing the contents of the stored handset address book.
(2) SetAddressEntry( ): This API command is issued by the BAR client to the embedded address book. The address book responds by replacing the contents of the specified address book entry (slot) with the contents of the given memory structure.
(3) GetAddressEntry( ): This API command is issued by the BAR client to the embedded address book. The address book responds by filling the contents of the given memory structure with the contents of an address book entry (slot). The address book only fills in the entries for those values it understands.
(4) ResetCallList( ): This API command is issued by the BAR client to the embedded handset call list manager. The call list manager responds by erasing the contents of the recent call list and missed call list.
(5) NotifyCommit( ): This API command is issued by the handset address book client to the embedded BAR client to indicate that a change has occurred to a particular slot within the handset address book. Multiple commit notifications may be issued by the handset address book client and it is up to the BAR client to track these notifications until proper one or more MMS message are formed.
(6) SendMessage( ): This API command is issued by the BAR client to the embedded MMS messaging subsystem within the handset. This command places the backup message into the client's outbox. In one embodiment, the message is a fully formed MMS message with a vCard attachment. The MMS message contains the appropriate message headers and a valid destination address for the BAR server endpoint.
   Note: Once an MMS message is placed into the message outbox, it is the responsibility of the MMS subsystem within the handset to deliver the MMS message using the network.
(7) ParseMessage( ): This API command is issued by the embedded MMS message router within the handset to the BAR client. This command informs the BAR client that a fully formed, “as-is,” message from the MMS inbox is available for parsing. The BAR client parses the MMS message contents and validate the message signature. Upon successful parsing, the BAR client will call the appropriate address book APIs to modify the handset address book.
(8) PeriodicCheck( ): This API command is periodically called by the handset firmware subsystem in order to invoke timing check functionality within the BAR client. In one embodiment, the BAR client returns from this function call within a maximum, short duration to avoid locking up the handset or generating a timer race condition.
   Note: In one embodiment, the BAR embedded client uses direct connectivity to the embedded handset configuration manager.
(9) GetTime( ): This API command is issued by the BAR client to the handset firmware in order to retrieve the current time to use as the time stamp for MMS messages sent to the server. In one embodiment, current time is handset local time and not GMT.
   Note: In one embodiment, the BAR embedded client uses direct connectivity to embedded handset timing services for the purpose of periodically checking its task queue and to determine the current time and date.
(10) GetServerAddress( ): This API command is issued by the BAR client to the handset firmware in order to retrieve the MMS destination address for the BAR server. The handset vendor may optionally provide the ability to set the value of this address within the handset configuration settings.
(11) IsEnabled( ): This API command is issued by the BAR client to the handset configuration firmware in order to retrieve the enabled state of the BAR application. The handset vendor may optionally provide the ability to set the value of this flag within the handset configuration settings. Ideally, this configuration is programmable by an over-the-air (OTA) configuration command.

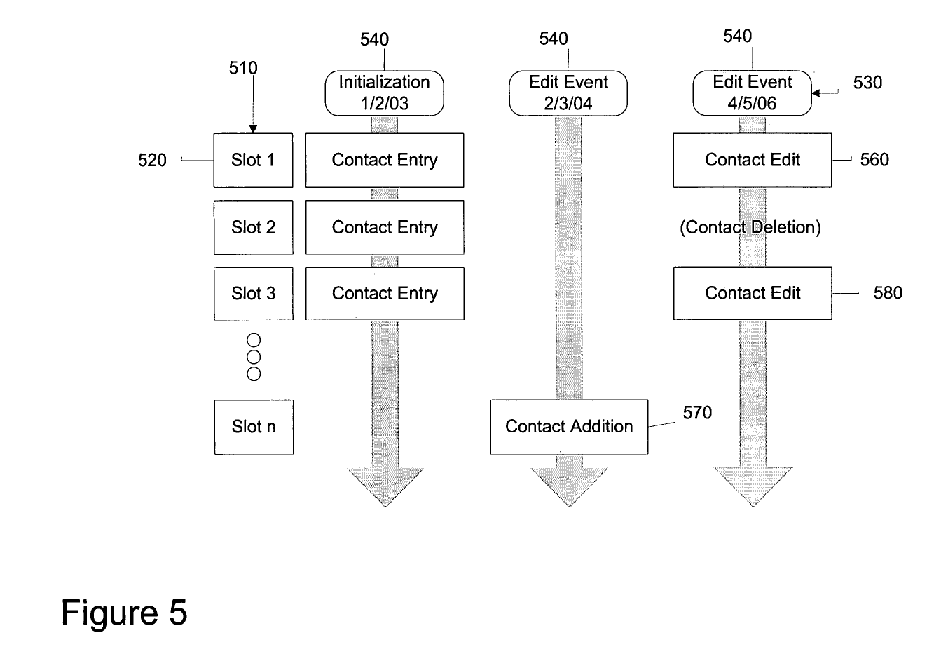

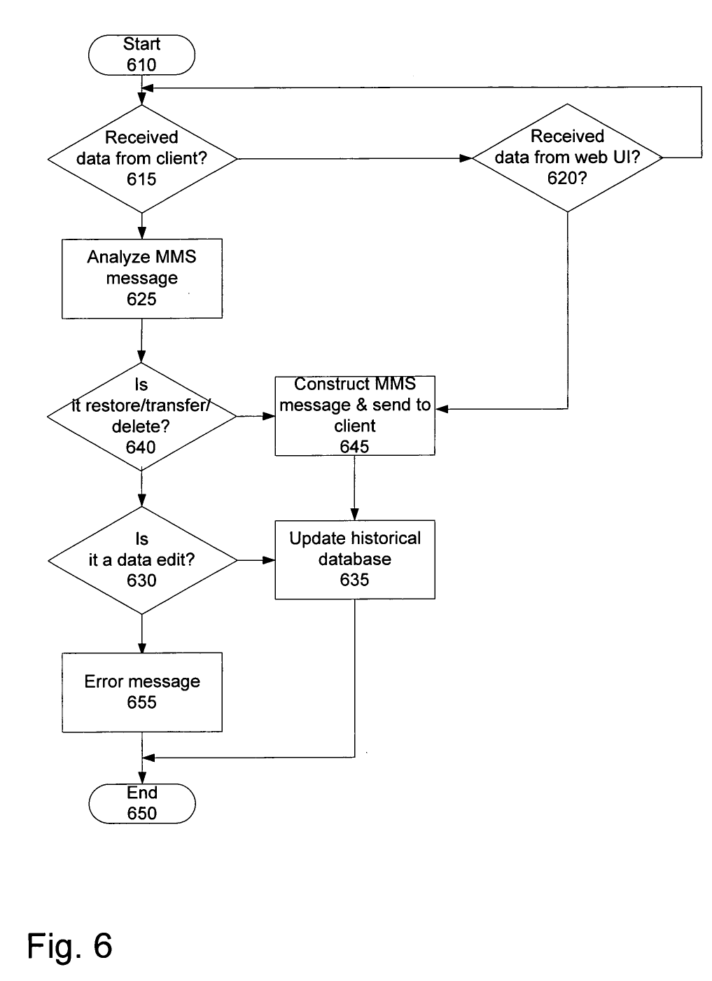

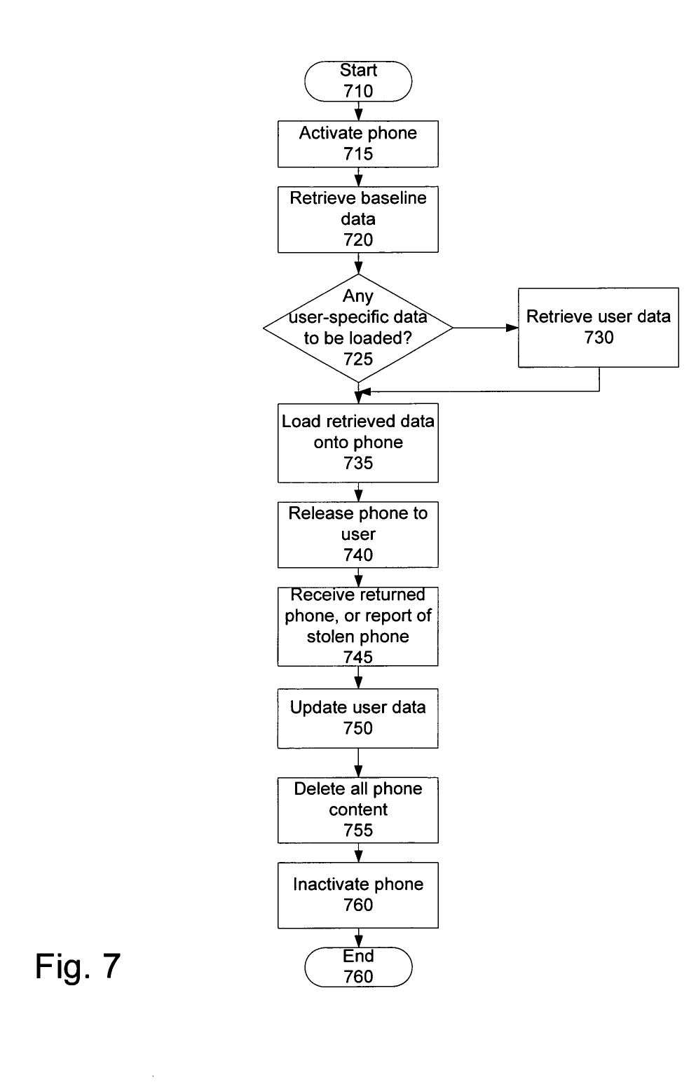

Data storage for address book information can be logically described by a two-dimensional data structure, illustrated as an example in FIG. 5. The first dimension 510 corresponds to the slot number 520, or index, of the particular contact data entry within the handset. The second dimension 530 corresponds to time normalized change events 540, moments in time when some or all of the information in the address book changed.

Using this two dimensional data construct, a historical archive of the address book can be reconstructed for any given date label.

In one embodiment, all contact information corresponding to a given slot number is considered a historical change to that slot. Additions 560 and modifications 550 are indicated by a non-empty record for a particular slot. Deletions 580 are indicated by an empty record for a particular slot. No record indicates that no change occurred within that slot at the given time.

It is possible that the date information sent by the handset to the server for a particular slot is in error. Specifically, the handset could send a date value that corresponds to a time prior to the time of the last update to that particular record. This is an error condition and is handled by the server. In one embodiment, the server will normalize any date entry corresponding to a particular record with a value prior to the previous entry for that record or with no value all, by substituting the current server time stamp. All records associated with a particular record entry are unique and sorted in ascending chronological order.

In general, address book backup information is unique per subscriber. There is no need to centralize the information into a single database. Because no records from multiple subscriber databases will ever be shared or linked, individual subscriber micro-databases are used, in one embodiment. In another embodiment, a simple flat file structure is used.

Because of storage limits inherent to the mobile handsets, it is not expected that any subscriber's database would exceed a thousand entries. The average subscriber database size is expected to contain fewer than 30 entries. For this reason, it is feasible for, but not required that, the BAR server application to perform in-memory database construction from persistent data using on-the-fly sorting rather than rely on a structured database system.

Provided that shared locking is available, the entire address book database for a subscriber can be stored in a subscriber data area as a file without concern for access collisions.

Subscriber address book information is private and is not viewable by unauthorized parties. Subscriber address book contents, in one embodiment, cannot be viewed by customer support personnel. Secured, backed up storage is provided on the BAR server, in one embodiment.

Individual subscriber address entries are keyed by logical slot number to correspond directly with a slot number within the handset. Multiple entries can exist for each handset slot, summarizing a history of changes to that slot. Entries are preserved for the life of the address book, in one embodiment.

In one embodiment, no data within the subscriber database is ever removed. Rather, the subscriber database contains a full historical record of modifications made to the address book on a per-slot basis. Each address book entry contains a time stamp, which can be used to re-construct the address book state as of a particular time.

For example, to reconstruct the address book state as of a particular time, the system select all records prior to the given time stamp and applies all records per slot in sequential order. The result will contain a historical representation of modifications made to date.

Additions are record entries that replace empty slots. Changes are record entries that replace previous record entries. Deletions are empty record entries that replace previous record entries. In this way, the present system provides a full backup, as well as a historical record of the user's address book.

Note that while only an address book was discussed herein, the same system may be applied to any structured data that is maintained on a user's handheld device, such as a contacts, calendars, media files, etc.

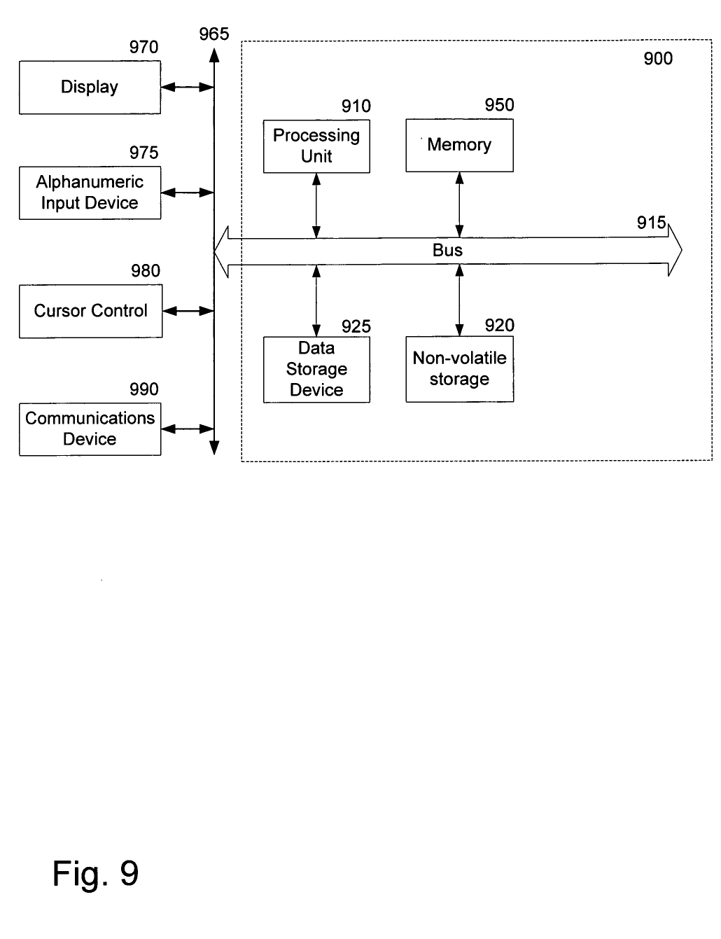

FIG. 9 is one embodiment of a computer system that may be used with the present invention. It will be apparent to those of ordinary skill in the art, however that other alternative systems of various system architectures may also be used.

The data processing system illustrated in FIG. 9 includes a bus or other internal communication means 915 for communicating information, and a processor 910 coupled to the bus 915 for processing information. The system further comprises a random access memory (RAM) or other volatile storage device 950 (referred to as memory), coupled to bus 915 for storing information and instructions to be executed by processor 910. Main memory 950 also may be used for storing temporary variables or other intermediate information during execution of instructions by processor 910. The system also comprises a read only memory (ROM) and/or static storage device 920 coupled to bus 915 for storing static information and instructions for processor 910, and a data storage device 925 such as a magnetic disk or optical disk and its corresponding disk drive. Data storage device 925 is coupled to bus 915 for storing information and instructions.

The system may further be coupled to a display device 970, such as a cathode ray tube (CRT) or a liquid crystal display (LCD) coupled to bus 915 through bus 965 for displaying information to a computer user. An alphanumeric input device 975, including alphanumeric and other keys, may also be coupled to bus 915 through bus 965 for communicating information and command selections to processor 910. An additional user input device is cursor control device 980, such as a mouse, a trackball, stylus, or cursor direction keys coupled to bus 915 through bus 965 for communicating direction information and command selections to processor 910, and for controlling cursor movement on display device 970.

Another device, which may optionally be coupled to computer system 900, is a communication device 990 for accessing other nodes of a distributed system via a network. The communication device 990 may include any of a number of commercially available networking peripheral devices such as those used for coupling to an Ethernet, token ring, Internet, or wide area network. The communication device 990 may further be a null-modem connection, or any other mechanism that provides connectivity between the computer system 900 and the outside world. Note that any or all of the components of this system illustrated in FIG. 9 and associated hardware may be used in various embodiments of the present invention.

It will be appreciated by those of ordinary skill in the art that any configuration of the system may be used for various purposes according to the particular implementation. The control logic or software implementing the present invention can be stored in main memory 950, mass storage device 925, or other storage medium locally or remotely accessible to processor 910.

It will be apparent to those of ordinary skill in the art that the system, method, and process described herein can be implemented as software stored in main memory 950 or read only memory 920 and executed by processor 910. This control logic or software may also be resident on an article of manufacture comprising a computer readable medium having computer readable program code embodied therein and being readable by the mass storage device 925 and for causing the processor 910 to operate in accordance with the methods and teachings herein.

The present invention may also be embodied in a handheld or portable device containing a subset of the computer hardware components described above. For example, the handheld device may be configured to contain only the bus 915, the processor 910, and memory 950 and/or 925. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

The present invention may also be embodied in a special purpose appliance including a subset of the computer hardware components described above. For example, the appliance may include a processor 910, a data storage device 925, a bus 915, and memory 950, and only rudimentary communications mechanisms, such as a small touch-screen that permits the user to communicate in a basic manner with the device. In general, the more special-purpose the device is, the fewer of the elements need be present for the device to function. In some devices, communications with the user may be through a touch-based screen, or similar mechanism.

It will be appreciated by those of ordinary skill in the art that any configuration of the system may be used for various purposes according to the particular implementation. The control logic or software implementing the present invention can be stored on any machine-readable medium locally or remotely accessible to processor 910. A machine-readable medium includes any mechanism for storing or transmitting information in a form readable by a machine (e.g. a computer). For example, a machine readable medium includes read-only memory (ROM), random access memory (RAM), magnetic disk storage media, optical storage media, flash memory devices, electrical, optical, acoustical or other forms of propagated signals (e.g. carrier waves, infrared signals, digital signals, etc.).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method of providing a backup and restore service comprising:
receiving from a client device a message generated responsive to an edit event, the message containing a change to an entry in client data, the entry having an associated slot;
storing the edit event with an associate date in a backup and restore server, the edit event tracking the change to the entry according to slot number; and
providing an ability to restore client data on the client device from the backup and restore server, in response to a user request.

2. The method of claim 1, where an edit event comprises one or more of the following: an addition of a new entry, a deletion of an entry, a change from a blank entry to a filled-in entry, and a change to some aspect of an entry.

3. The method of claim 1, further comprising:
in response to receiving a delete request, sending a message to the client to instruct it to delete all entries in the client data.

4. The method of claim 1, further comprising:
including with the message a signature which validates the authenticity of the sender.

5. The method of claim 1, further comprising:
providing a web interface to enable a user to edit the client data on the server.

6. The method of claim 5, further comprising:
generating a message to the client to instruct it to update the client data in accordance with changes made on the server.

7. The method of claim 1, further comprising:
enabling a user to transfer the client data to a new client device, from the backup and restore server.

8. The method of claim 1, further comprising:
constructing a multimedia messaging system (MMS) message to send selected client data from the backup and restore server to the client device.

9. The method of claim 8, wherein the client data is an address book, and the message body contains a vCard.

10. The method of claim 1, further comprising:
notifying the client via session initiation protocol (SIP) to accept new client data records.

11. The method of claim 1, wherein the client device is a wirelessly connected communication device, such as a mobile phone.

12. The method of claim 1, wherein the client device is a fixed line connected communication device, such as a voice-over-IP (VoIP) phone.

13. A backup and restore server comprising:
client data including a plurality of records;
a resetting logic to erase a content of a client device, the erasing removing all of the records from the device; and
a restore/transfer logic to reset the content of the client device with the client data stored on the server.

14. The server of claim 13, wherein the client data comprises:
baseline data associated with an authority issuing the client device; and
user data associated with a particular user to whom the client device belongs.

15. The server of claim 13, further comprising:
client data including historical data.

16. The server of claim 15, wherein the restore/transfer logic further enables a user to reset the client device to a previous state.

17. The server of claim 13, further comprising:
an activation logic to activate the client device when it is assigned to a user and to deactivate the client device when it is returned.

18. The server of claim 13, wherein the server acts as a fleet server, enabling a client device to be initialized with default data when it is provided to a user, and returned to a pristine state when the user returns the client device.

19. The server of claim 18, wherein the client device is further initialized with the user's own data, in addition to the default data.

20. The server of claim 18, wherein the server acts as a backup and transfer server to enable a user to transfer the client data to a new client device.
